(19) United States
(12) Patent Application Publication
(10) Pub. No.: US 2013/0113700 A1
(43) Pub. Date: May 9, 2013

(54) OPERATING AND MONITORING SCREEN DISPLAYING APPARATUS AND METHOD

(71) Applicant: Yokogawa Electric Corporation, Tokyo (JP)

(72) Inventors: Shinichi Nagai, Yokohama-shi (JP); Yasunori Kobayashi, Musashino-shi (JP)

(73) Assignee: YOKOGAWA ELECTRIC CORPORATION, Tokyo (JP)

(21) Appl. No.: 13/672,848

(22) Filed: Nov. 9, 2012

(30) Foreign Application Priority Data
Nov. 9, 2011 (JP) 2011-245546

(51) Int. Cl. G09G 5/00; G06F 3/01

(52) U.S. Cl. CPC G09G 5/00; G06F 3/01
USPC 345/156; 345/1.3

(57) ABSTRACT

An operating and monitoring screen displaying apparatus according to the present disclosure selects a screen among a plurality of split display screens displaying information about a part of a process in a plant and displays the selected screen as an operating and monitoring screen. The apparatus includes a receipt unit which receives a selection of a screen to be displayed among a plurality of split display screens; a split screen display unit which displays the screen selected through the receipt unit; and a map display unit which displays a map in which process elements constituting the process are associated with display areas, and indicates, on the map, a display area associated with a process element included in the screen being displayed by the split screen display unit.

### BACKGROUND OF THE INVENTION

The present disclosure relates to an operating and monitoring screen displaying apparatus and an operating and monitoring screen displaying method, which selects a screen among a plurality of split display screens which display information about a part of a process in a plant, and displays the selected screen as an operating and monitoring screen.

In the case of a large plant, when operating conditions of the plant are monitored by an operating and monitoring screen, it is difficult to display all internal devices of the plant on a single screen. For this reason, typically, a part of a process flow is displayed on a split screen along the process flow. Generally, the following information is displayed on the split display screen which displays a part of a process flow. On the split display screen, detailed information about a part of a plant, operating conditions, and an arrow indicating a relation with other screen are displayed in a full screen. Information displayed on the screen includes, for example, the following information. (1) Process flow, (2) Measurement point (tag name) of process data such as flow rate and temperature, and a current value thereof, (3) Operational status of a pump, and (4) Abnormal value warning (alarm). When an operator wants to acquire information about an area that is not displayed on the split display screen, the operator can display an upper or lower portion of the process flow, for example, by clicking an arrow or the like disposed on the left and right of the split display screen, or can display a next split display screen by directly inputting a screen number the operator wants to move to.

In an operating and monitoring display device disclosed in Japanese Patent Application Laid-Open No. 2003-67050, a system message window is displayed on a split screen.

### SUMMARY

An operating and monitoring screen displaying apparatus of the present disclosure, which selects a screen among a plurality of split display screens displaying information about a part of a process in a plant, and displays the selected screen as an operating and monitoring screen, includes, for example, a receipt unit which receives a selection of a screen to be displayed among a plurality of split display screens; a split screen display unit which displays the screen selected through the receipt unit; and a map display unit which displays a map in which process elements constituting the process are associated with display areas, and indicates, on the map, a display area associated with a process element included in the screen being displayed by the split screen display unit.

### BRIEF DESCRIPTION OF DRAWINGS

FIG. 1 is a block diagram illustrating a configuration of a field control system to which an operating and monitoring device is applied as an operating and monitoring screen displaying apparatus according to an embodiment;

FIG. 2 is a diagram illustrating a display example in a display screen of an operating and monitoring device;

FIG. 3 is a diagram illustrating an example of a map which is displayed by a map display unit;

FIG. 4 is a diagram illustrating a representation example of a waterfall diagram which indicates the progress status of a series of tasks;

FIG. 5 is a diagram illustrating an example of a display screen which is displayed at the same time as the waterfall diagram; and

FIG. 6 is a diagram illustrating an example of an expandable map.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In the conventional art, if an operator does not fully know which portion of a process flow is displayed on a split display screen, it may be difficult to effectively use the split display screen which is currently being displayed. For example, an operator may want to display tags, which are spaced apart on the displayed process flow, on the same screen. In this case, if the operator does not understand the design base of the screen, it is difficult to know the location of the apart tag and its information displayed on the screen. Therefore, limitations to screen design are getting stricter. Hence, for example, tags which can be displayed on a single split display screen are limited to tags which are close to each other on the process flow. Therefore, it is difficult to create a split display screen which can represent very useful information for aparting.

Also, if the operator does not remember an overall view of the process flow and a part of the process flow being displayed on the split display screen, it is difficult to select an appropriate split display screen. This point may become an obstacle to executing an operation task and training less experienced operators. There is a cognitive limitation to phenomena that can be recognized at a time by a human. It is reasonable to display complex plant information on split screens. However, it is difficult to know a relation between the split screens and instantly request a desired screen. For this reason, it is likely that the load imposed on the operator will be increased and the operator's judgment of the situation will be delayed.

One object of the present disclosure is to provide an operating and monitoring screen displaying apparatus and an operating and monitoring screen displaying method, which can enable an operator to easily identify a portion being displayed on a split display screen.

An operating and monitoring screen displaying apparatus of the present disclosure, which selects a screen among a plurality of split display screens displaying information about a part of a process in a plant, and displays the selected screen as an operating and monitoring screen, includes, for example, a receipt unit which receives a selection of a screen to be displayed among a plurality of split display screens; a split screen display unit which displays the screen selected through the receipt unit; and a map display unit which displays a map in which process elements constituting the process are associated with display areas, and indicates, on the map, a display area associated with a process element included in the screen being displayed by the split screen display unit.

According to the operating and monitoring screen displaying apparatus, for example, the map in which the process elements constituting the process are associated with the display areas is displayed. In addition, the display area associated with the process element included in the screen being displayed by the split screen display unit is displayed in the map. Therefore, the operator can easily identify the process element included in the screen being displayed by the split screen display unit.

The operating and monitoring screen displaying apparatus of the present disclosure may further include, for example, a detailed screen display unit which displays a screen indicating details about a process element associated with the display area according to an operation on the display area of the map being displayed by the map display unit.

The map display unit may display alarm information about a process element in a corresponding display area.

The operating and monitoring screen displaying apparatus of the present disclosure may further include, for example, a screen information display unit which displays information specifying a screen displayed by the split screen display unit, around the map displayed by the map display unit.

The process elements associated with the respective display areas in the map may be equal, without regard to the screen being displayed by the split screen display unit.

The map display unit may assign a series of task processes, arranged in time series, to the respective display areas of the map, and display progress status of the corresponding processes in the respective display areas.

An operating and monitoring screen displaying method of the present disclosure, which selects a screen among a plurality of split display screens displaying information about a part of a process in a plant, and displays the selected screen as an operating and monitoring screen, includes: a receiving step of receiving a selection of a screen to be displayed among a plurality of split display screens; a split screen displaying step of displaying the screen selected through the receiving step; and a map displaying step of displaying a map in which process elements constituting the process are associated with display areas, and indicates, on the map, a display area associated with a process element included in the screen being displayed by the split screen display unit.

According to the operating and monitoring screen displaying method, the map in which the process elements constituting the process are associated with the display areas is displayed. In addition, the display area associated with the process element included in the screen being displayed by the split screen displaying step is displayed in the map. Therefore, the operator can easily identify the process element included in the screen being displayed by the split screen displaying step.

According to the operating and monitoring screen displaying apparatus of the present disclosure, the map in which the process elements constituting the process are associated with the display areas is displayed. In addition, the display area associated with the process element included in the screen being displayed by the split screen display unit is displayed in the map. Therefore, the operator can easily identify the process element included in the screen being displayed by the split screen display unit.

Also, according to the operating and monitoring screen displaying method of the present disclosure, the map in which the process elements constituting the process are associated with the display areas is displayed. In addition, the display area associated with the process element included in the screen being displayed by the split screen displaying step is displayed in the map. Therefore, the operator can easily know the process element included in the screen being displayed by the split screen displaying step.

Hereinafter, an operating and monitoring screen displaying apparatus according to one embodiment of the present disclosure will be described.

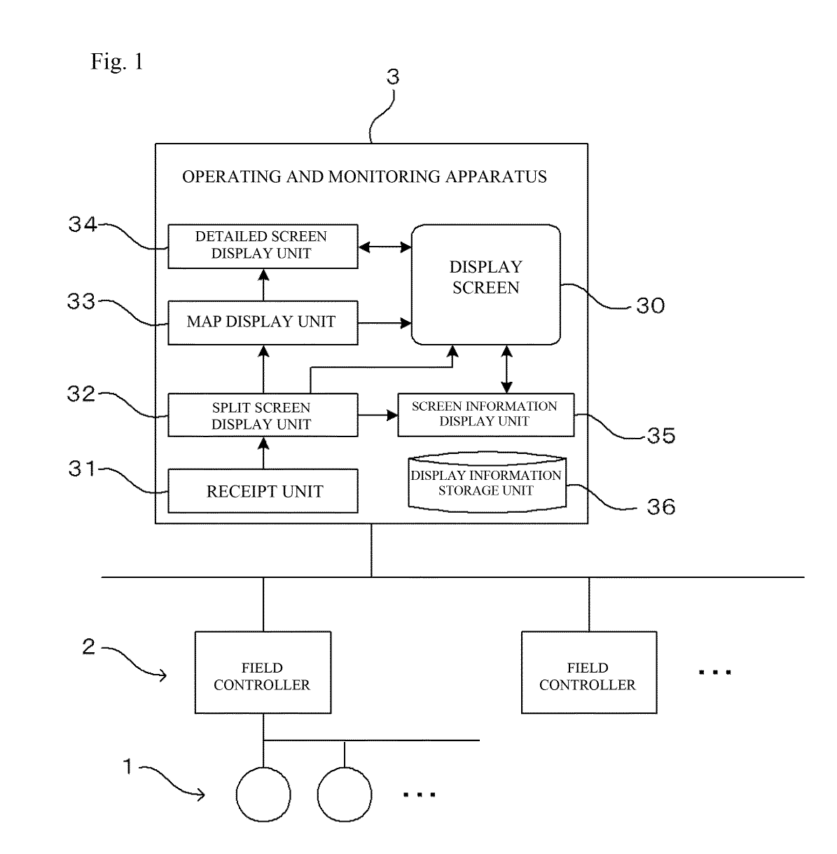

FIG. 1 is a block diagram illustrating a configuration of a field control system to which an operating and monitoring device is applied as an operating and monitoring screen displaying apparatus according to an embodiment.

As illustrated in FIG. 1, the field control system includes a plurality of field devices 1, a plurality of field controllers 2, and an operating and monitoring device 3. The field devices 1 include, for example, a variety of sensors and valves distributed in a plant. The field controllers 2 are connected to the field devices 1. The operating and monitoring device 3 is connected to the controllers 2. The operating and monitoring device 3 operates and monitors the field devices 1 through the field controllers 2. The operating and monitoring device 3 includes a display screen 30 for monitoring the operation of the plant.

As illustrated in FIG. 1, the operating and monitoring device 3 includes receipt unit 31, split screen display unit 32, map display unit 33, detailed screen display unit 34, screen information display unit 35, and display information storage unit 36. The receipt unit 31 receives a selection of a screen to be displayed among a plurality of split display screens. The split screen display unit 32 displays the screen, which is selected through the receipt unit 31, on the display screen 30. The map display unit 33 displays a map on the display screen 30. In the map, a process element constituting a process is associated with a display area. In addition, the map display unit 33 indicates, on the map, the display area associated with the process element included in the screen being displayed by the split screen display unit 32. The detailed screen display unit 34 displays, on the display screen 30, a screen which indicates details about the process element associated with the display area according to an operation on the display area of the map being displayed by the map display unit 33. The screen information display unit 35 displays information, which specifies the screen being displayed by the split screen display unit 32, around the map being displayed by the map display unit 33. The display information storage unit 36 stores data of the display screen 30 and a variety of information for screen display.

Next, the operation related to the screen display in the operating and monitoring device 3 will be described.

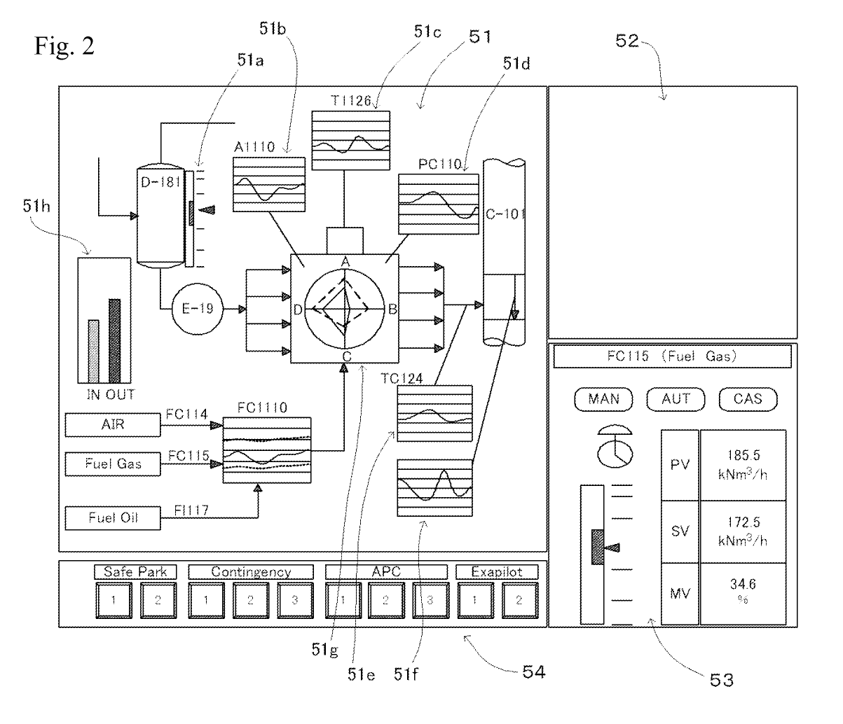

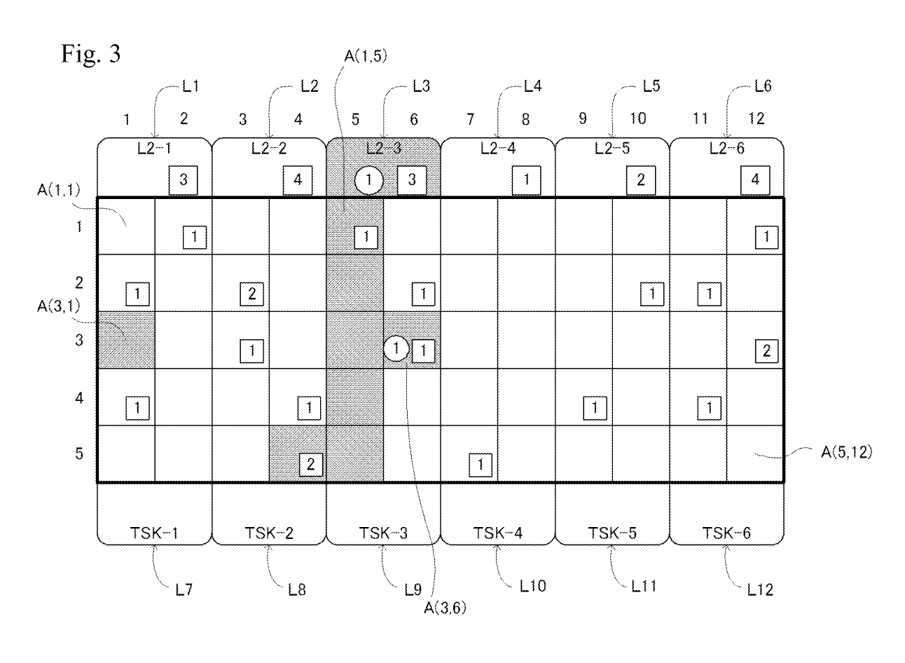

FIG. 2 is a diagram illustrating a display example in the display screen 30 of the operating and monitoring device 3. FIG. 3 is a diagram illustrating an example of the map which is displayed by the map display unit 33.

In the example illustrated in FIG. 2, in area 51, for example, a split screen is displayed by the split screen display unit 32. In area 52, for example, a map (FIG. 3) is displayed by the map display unit 33. In area 53, for example, an operation screen is displayed to change a setting value or to monitor a process value or the like. In area 54, for example, a group of emergency buttons to be operated in case of emergency are displayed.

As illustrated in FIG. 3, in the map displayed in the area 52, for example, the entire plant is divided into sixty sections, based on the process flow. The respective sections are associated with rectangular display areas A(n, m) arranged in a 5×12 matrix form. In the display area A(n, m), n represents a position (coordinate) in a vertical direction, and m represents a position (coordinate) in a horizontal direction. The positions of the display areas A(n, m) are defined based on the process flow. The adjacent sections on the process flow are assigned to the adjacent display areas A(n, m). In the present disclosure, the section corresponds to the “process element”.

Also, in the upper side of the map, labels L1 to L6 for selecting the split screen displayed in the area 51 are disposed. The respective labels are previously associated with different split screens. FIG. 3 illustrates an example in which the label L3 associated with the split screen “L2-3” is selected by an operator on the display screen 30. In the area 51, the split screen “L2-3” is displayed. The operation of selecting the display screen 30 is received through the receipt unit 31 (FIG. 1). The screen information display unit 35 displays the selected label L3 with a predetermined color. In this manner, the selection of the label L3 is indicated. Also, in the area 51, the split screen “L2-3” associated with the label L3 is displayed by the split screen display unit 32.

On the respective split screens displayed in the area 51, for example, up to nine monitoring targets are displayed. In the example of FIG. 2, eight monitoring targets 51a to 51h are displayed. In this manner, the number of the display elements displayed on the respective split screens is limited to below a predetermined number. Therefore, it is possible to avoid an operator's confusion and a dilution of an operator's consciousness due to excessive information. Therefore, the operator can concentrate on the execution of given tasks. The display element includes a trend graph of a process value or the like, a graphic display indicating a liquid level or the like, a graph representing a material balance, and a graph indicating a heat balance. Also, the display element includes a parameter itself directly acquired from the plant, a parameter by processing the parameter directly acquired from the plant, a parameter by processing a plurality of parameters, and a combination of parameters.

When a label selecting operation is performed, the receipt unit 31 receives the label selecting operation. The display area corresponding to the section displayed on the split screen associated with the selected label is displayed with a predetermined color by the map display unit 33 (FIG. 1). In this manner, the range displayed on the split screen is represented on the map. For example, in the example of FIG. 3, sections corresponding to a display area A(1, 5), a display area A(2, 5), a display area A(3, 1), a display area A(3, 5), a display area A(3, 6), a display area A(4, 5), a display area A(5, 4), and a display area A(5, 5) are displayed on the split screens of the area 51.

Information which associates the labels L1 to L6, the sections of the plant, and image data of the split screens with one another is stored as display information in the display information storage unit 36 (FIG. 1). The display information is appropriately read out by the split screen display unit 32, the map display unit 33, and the screen information display unit 35. In this manner, the screen associated with the display information is displayed.

Also, in the respective display areas A(n, m) on the map, alarm activation conditions in the corresponding sections are displayed. The number of mid-priority alarm activations is represented by figures enclosed, for example, by circles. The number of low-priority alarm activation is represented by figures enclosed, for example, by rectangles. For example, in the example of FIG. 3, in the section of the display area A(3, 6), one mid-priority alarm and one low-priority alarms are activated. In the section of the display area A(1, 5), one low-priority alarm is activated.

Also, in the respective labels L1 to L7, the total number of alarms activated in the sections associated with the respective split screens is displayed. The number of mid-priority alarm activations is represented by figures, for example, enclosed by circles. The number of low-priority alarm activations is represented by figures enclosed, for example, by rectangles. For example, in the example of FIG. 3, in the sections of the split screen “L2-3” associated with the label L3, one mid-priority alarm and three low-priority alarms are activated. Likewise, for example, in the sections of the split screen “L2-4” associated with the label L4, one low-priority alarm is activated.

Such alarm information is acquired from the plant in real time and is reflected to the screen display.

Also, detailed screens for the respective sections associated with the respective display areas A(n, m) on the map are provided. When the display area A (n, m) is clicked, the detailed screen display unit 34 displays the detailed screens of the corresponding sections on the display screen 30. The information about the correspondence relation between the display area A(n, m) and the detailed screen in each section is stored in the display information storage unit 36. The detailed screen display unit 34 reads out such information and reflects the read information to the screen display.

As described above, in the operating and monitoring screen displaying apparatus of the present embodiment, which range of the plant the split screen being currently displayed covers is made obvious by the map displayed in the area 52. For example, in the example of FIG. 3, the section associated with the label display area A(3, 1) among the sections associated with the split screen “L2-3” is spaced apart from other sections. The operator can easily know these relations. Therefore, the operator can immediately understand the content of the information indicated by the split screen “L2-3”. Also, the expansion to other split screen(s) is also easy.

Also, the respective display areas A(n, m) on the map are assigned to the corresponding sections. Therefore, it is possible to easily provide the operation screen covering a wide range. For example, when the screens are expanded based on a hierarchical structure, it is difficult to assign the sections spaced apart on the hierarchical structure to the same split screen. Meanwhile, the present embodiment can solve this problem.

Also, in the present embodiment, an alarm generation situation is indicated on the map. Therefore, the operator can get a quick overview of the entire plant operating condition. Hence, the operator can take a prompt and accurate action. As a result, the safety of the operation can be ensured.

In addition, during a normal operation in the conventional system, the frequency of use of detailed screens is high and they are not stratified as the present ambodiment. Therefore, in order to display the detailed screen, the conventional system requires a plurality of operation steps. Meanwhile, in the present embodiment, the operator can access the detailed screen of the corresponding section by clicking the display area A(n, m) of the map. Therefore, the present embodiment can support the representation of the entire plant and the excellent access to the detailed screen at the same time.

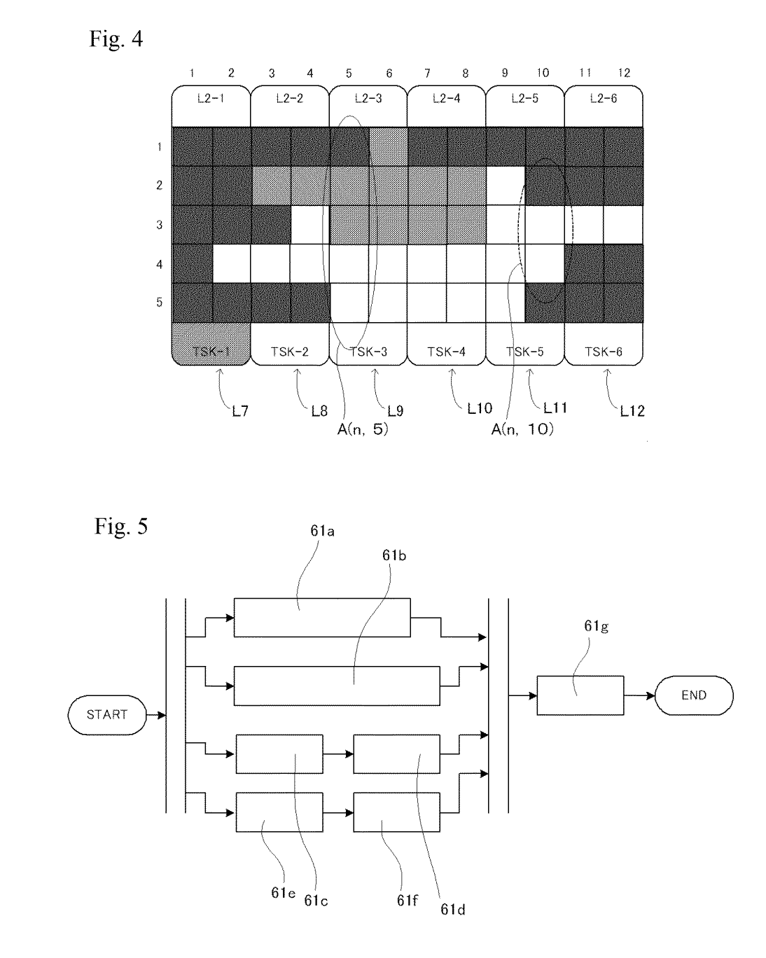

Next, FIG. 4 illustrates a representation example of a waterfall diagram using the map displayed in the area 52. The waterfall diagram indicates the progress status of a series of tasks. In the example of FIG. 4, a task is assigned to “m” of the display area A(n, m), and a time zone is assigned to “n” of the display area A(n, m). In FIG. 4, a direction from top to bottom corresponds to the passage of time. A black display area A(n, m) indicates that there is no task process. A white display area A(n, m) indicates that there is an unfinished task process. A display area A(n, m) with hatched lines indicates that there is a finished task process.

In the example of FIG. 4, labels L7 to L12 indicating a group of tasks are displayed in a lower side of the map. By an operation of selecting one of the labels, a waterfall diagram for a series of corresponding tasks is displayed. For example, as illustrated in FIG. 4, when an operation of selecting the label L7 is performed, hatched lines are displayed in the label L7. In this manner, the selection of the label L7 is indicated. Also, a waterfall diagram for a series of tasks “TSK-1” assigned to the label L7 is displayed. For example, it is indicated that eleven tasks are included in a series of tasks “TSK-1” as tasks to be executed in parallel. These tasks are represented in the display area A(n, 2), the display area A(n, 3), the display area A(n, 4), the display area A(n, 5), the display area A(n, 6), the display area A(n, 7), the display area A(n, 8), the display area A(n, 9), the display area A(n, 10), the display area A(n, 11), and the display area A(n, 12).

Also, for example, the task displayed in the display area A(n, 5) indicates a configuration that is made by the four-step operation or procedure arranged in time series over the display area A(2, 5) to the display area A(5, 5). Furthermore, in this task, the completion of processes corresponding to the display area A(2, 5) and the display area A(3, 5), and non-completion of post-processing are represented.

Likewise, for example, the task displayed in the display area A(n, 10) indicates a configuration that is made by the two-step operation arranged in time series over the display area A(3, 10) to the display area A(4, 10). Furthermore, in this task, non-completion of all processes is represented.

FIG. 5 is a diagram illustrating a display example in the area 51 when the waterfall diagram is displayed using the map of the area 52. In the example of FIG. 5, a process included in a series of tasks selected by an operation of selecting the labels L7 to L12, and a process diagram illustrating the content of the process are displayed. In blocks 61a to 61g, the contents of the respective processes are described. In this manner, the process diagram corresponding to the group of selected tasks is displayed in the area 51. Therefore, the operator can check the process contents of the respective tasks included in the group of tasks, and the progress status of the respective processes state on the single screen.

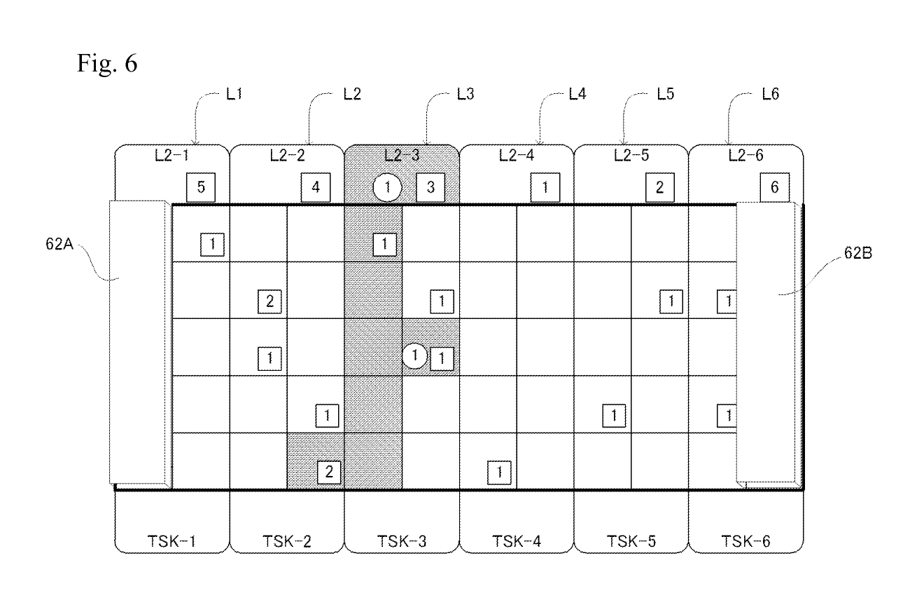

Next, FIG. 6 is a diagram illustrating an example of an expandable map. In the example of FIG. 6, a folded portion 62A is provided on the left of the map illustrated in FIG. 3, and a folded portion 62B is provided on the right thereof. By operating this portion, the map can be expandable in a horizontal direction. When the plant is large in scale or complicated, the entire plant may be beyond the scope of the single map displayed on the screen. In this case, only a part of the plant is displayed in the map, and the map is expanded in a horizontal or vertical direction. In this manner, it is possible to display a desired portion of the map on the screen.

As described above, according to the operating and monitoring screen displaying apparatus of the present disclosure, the map in which the process elements constituting the process are associated with the display areas is displayed. In addition, the display area associated with the process element included in the screen being displayed by the split screen display unit is displayed in the map. Therefore, the operator can easily identify the process element included in the screen being displayed by the split screen display unit. Also, according to the operating and monitoring screen displaying method of the present disclosure, the map in which the process elements constituting the process are associated with the display areas is displayed. In addition, the display area associated with the process element included in the screen being displayed by the split screen displaying step is displayed in the map. Therefore, the operator can easily identify the process element included in the screen being displayed by the split screen displaying step.

The present disclosure can be widely applied to, for example, treating processes related to petroleum, chemicals, or the like, a continuous process or complex process of food, paper and pulp, drug, water treatment, electricity, gas, or the like, and a production process for manufacturing a product through multiple procedures.

The scope of application of the present disclosure is not limited to the embodiment. The present disclosure can be widely applied to an operating and monitoring screen displaying apparatus and an operating and monitoring screen displaying method, which selects a screen among a plurality of split display screens which display information about a part of a process in a plant, and displays the selected screen as an operating and monitoring screen.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. An operating and monitoring screen displaying apparatus, which selects a screen among a plurality of split display screens displaying information about a part of a process in a plant, and displays the selected screen as an operating and monitoring screen, the operating and monitoring screen displaying apparatus comprising:
a receipt unit configured to receive a selection of a screen to be displayed among a plurality of split display screens;
a split screen display unit configured to display the screen selected through the receipt unit; and
a map display unit configured to display a map in which process elements constituting the process are associated with display areas, and indicates, on the map, a display area associated with a process element included in the screen being displayed by the split screen display unit.

2. The operating and monitoring screen displaying apparatus according to claim 1, further comprising:
a detailed screen display unit configured to display a screen indicating details about a process element associated with the display area according to an operation on the display area of the map being displayed by the map display unit.

3. The operating and monitoring screen displaying apparatus according to claim 1, wherein the map display is configured to display alarm information about a process element in a corresponding display area.

4. The operating and monitoring screen displaying apparatus according to claim 1, further comprising:
a screen information display unit configured to display information specifying the screen being displayed by the split screen display unit, around the map being displayed by the map display unit.

5. The operating and monitoring screen displaying apparatus according to claim 1, wherein the process elements associated with the respective display areas in the map are the same, without regard to the screen being displayed by the split screen display unit.

6. The operating and monitoring screen displaying apparatus according to claim 1, wherein the map display unit is configured to assign a series of task processes, arranged in time series, to the respective display areas of the map, and is configured to display progress status of the corresponding processes in the respective display areas.

7. An operating and monitoring screen displaying method, which selects a screen among a plurality of split display screens displaying information about a part of a process in a plant, and displays the selected screen as an operating and monitoring screen, the operating and monitoring screen displaying method comprising the following steps:
a receiving step of receiving a selection of a screen to be displayed among a plurality of split display screens;
a split screen displaying step of displaying the screen selected through the receiving step; and
a map displaying step of displaying a map in which process elements constituting the process are associated with display areas, and indicates, on the map, a display area associated with a process element included in the screen being displayed by the split screen display unit.
